(19) United States
(12) Patent Application Publication
(10) Pub. No.: US 2012/0048246 A1
(43) Pub. Date: Mar. 1, 2012

(54) EGR MIXER

(75) Inventors: Hiroyuki TAKAGI, Kariya-city (JP); Toshio HAYASHI, Obu-city (JP); Yoshitaka NISHIO, Nagoya-city (JP)

(73) Assignee: DENSO CORPORATION, Kariya-city (JP)

(21) Appl. No.: 13/178,774

(22) Filed: Jul. 8, 2011

(30) Foreign Application Priority Data
Aug. 26, 2010 (JP) 2010-189668

(51) Int. Cl. F02M 25/07

(52) U.S. Cl. 123/568.15

(57) ABSTRACT

An EGR mixer has a mixing shell which defines a mixing cavity only on the down side, and does not define the mixing cavity on the up side. The EGR mixer has a primary internal opening for fresh air, which is formed so that an opening plane is inclined to a side so that the opening plane faces a secondary internal opening for exhaust gas. The primary internal opening and the secondary internal opening are arranged to allow exhaust gas to enter into the primary internal opening. The exhaust gas restricts a fresh air flow so that the fresh air flow creates increased vacuum. It is possible to suppress pressure loss and to increase an amount of exhaust gas.

### CROSS REFERENCE TO RELATED APPLICATION

This application is based on Japanese Patent Application No. 2010-189668 filed on Aug. 26, 2010, the contents of which are incorporated herein by reference in its entirety.

### FIELD OF THE INVENTION

The present disclosure relates to an apparatus, an EGR mixer, for mixing fresh air and exhaust gas in an exhaust gas recirculation (EGR) system.

### BACKGROUND OF THE INVENTION

Conventionally, an exhaust gas recirculation system (EGR) is known in this field. The EGR system returns a part of exhaust gas exhausted from the internal combustion engine to an intake line, and makes the internal combustion engine inhales the exhaust gas. To perform exhaust gas recirculation process, it is known to employ an EGR mixer, which creates mixture of fresh air and exhaust gas by mixing a part of the exhaust gas into fresh air.

JP-A-2007-092592 discloses an EGR mixer which mixes fresh air and exhaust gas by generating the Venturi effect on a fresh air flow and sucking exhaust gas by the fresh air flow. That is, the EGR mixer using the Venturi effect increases velocity of the fresh air flow and decreases pressure of fresh air by restricting the fresh air flow, and sucks exhaust gas into the fresh air flow by creating vacuum by ejecting fresh air with decreased pressure.

In order to improve sucking performance of exhaust gas, it is necessary to create deep and great vacuum by more narrowly restricting the fresh air flow. Therefore, attempt to improve sucking performance may adversely increase pressure loss in the fresh air flow. In another aspect, conventional designs of the EGR mixers could not obtain a sufficiently wide opening on a sucking opening for exhaust gas to a vacuum region created by the fresh air flow. Therefore, conventional EGR mixers could not supply sufficient amount of exhaust gas.

### SUMMARY OF THE INVENTION

It is an object of the present invention to provide an EGR mixer which can overcome the above mentioned problem. It is another object of the present invention to provide an EGR mixer being capable of suppressing pressure loss and increasing an amount of exhaust gas.

In one of aspects of the present invention, an EGR mixer for mixing fresh air and exhaust gas is provided. The EGR mixer comprises primary inlet pipe which ejects fresh air with increased velocity and decreased pressure by restricting a fresh air flow. The EGR mixer comprises mixing shell connected to the primary inlet pipe and defining a mixing cavity, which sucks exhaust gas into the mixing cavity by using vacuum created by ejected fresh air and mixes fresh air and exhaust gas.

The mixing shell defines primary internal opening which is an opening for ejecting fresh air from the primary inlet pipe into the mixing cavity. The mixing shell defines secondary internal opening which is an opening for introducing exhaust gas into the mixing cavity, and opens at a radial outside of fresh air flow from the primary internal opening. The mixing shell defines external opening which is an outlet opening for mixture of fresh air and exhaust gas.

The primary internal opening defines an opening plane on which the primary internal opening opens to the mixing cavity, and is formed so that the opening plane is positioned to intersect a center axis of the primary inlet pipe at a non-right angle. According to the invention, it is possible to suppress pressure loss caused by excessive expansion of fresh air when fresh air is ejected from the primary internal opening.

The primary internal opening is also formed so that the opening plane is inclined to face the secondary internal opening. The secondary internal opening is positioned at a position where exhaust gas flowing out from the secondary internal opening can pass through the primary internal opening by flowing in straight along a secondary flow direction which corresponds to a flow direction of exhaust gas at the secondary internal opening. According to the invention, it is possible to push the fresh air flow against an inner wall of in the primary inlet pipe by allowing exhaust gas entering into the primary internal opening. The exhaust gas can effectively restrict a fresh air flow. Therefore, the fresh air flow can create increased vacuum by increased velocity caused by the exhaust gas entered into the primary internal opening. Therefore, it is possible to increase sucking power to exhaust gas.

The mixing shell defines the mixing cavity only on a side to the opening plane where the secondary internal opening is placed. According to the invention, it is possible to reduce drifting flow of exhaust gas which does not directed toward the primary internal opening. The exhaust gas can effectively restrict a fresh air flow. Therefore, the fresh air flow can create increased vacuum by increased velocity caused by the exhaust gas entered into the primary internal opening. Therefore, it is possible to increase sucking power to exhaust gas.

According to the invention, it is possible to provide an EGR mixer which can suppress pressure loss and increase an amount of exhaust gas.

In one of aspects of the present invention, the mixing shell is provided by a part of an imaginary cylindrical pipe which is imaginarily disposed about a center axis of the primary inlet pipe to surround the primary inlet pipe, the part is only disposed on the side to the opening plane where the secondary internal opening is placed. The mixing cavity is formed in a fan shape with a center angle equal to or less than 180 degrees at a cross section perpendicular to the center axis. Wording of the fan shape is intended to include both a sector of a circle and a sector of an ellipse.

In one of aspects of the present invention, the mixing cavity defines cross sectional area which gradually decreased along flow direction to downstream within a region from the primary internal opening to the external opening. According to the invention, it is possible to suppress pressure loss of exhaust gas flowing from the secondary internal opening to the external opening. Contrary to the invention, if the cross sectional area of the mixing cavity is excessively decreased, exhaust gas may create greater pressure loss.

In one of aspects of the present invention, the primary internal opening and the secondary internal opening are arranged so that an upstream end of a projected area of the primary internal opening is positioned on an upstream side to an upstream end of a projected area of the secondary internal opening, where an upstream side and a downstream side are defined based on a direction of fresh air flow on the center axis of the primary inlet pipe, and where the primary internal opening and the secondary internal opening are projected along the secondary flow direction onto a projection plane perpendicular to the secondary flow direction.

According to the invention, it is possible to suppress pressure loss of exhaust gas. Contrary to the invention, if the upstream end of the primary internal opening is positioned on a downstream side to the upstream end of the secondary internal opening, exhaust gas ejected from the secondary internal opening may collide onto a wall of the primary inlet pipe at an upstream side to the primary internal opening, and create pressure loss, for example.

In one of aspects of the present invention, the primary internal opening and the secondary internal opening are arranged so that a downstream end of a projected area of the primary internal opening is positioned on a downstream side to a downstream end of a projected area of the secondary internal opening, where an upstream side and a downstream side are defined based on a direction of fresh air flow on the center axis of the primary inlet pipe, and where the primary internal opening and the secondary internal opening are projected along the secondary flow direction onto a projection plane perpendicular to the secondary flow direction.

According to the invention, the exhaust gas ejected from the secondary internal opening surely passes the primary internal opening. The exhaust gas can effectively restrict a fresh air flow. Therefore, the fresh air flow can create increased vacuum by increased velocity caused by the exhaust gas entered into the primary internal opening. Therefore, it is possible to increase sucking power to exhaust gas.

In one of aspects of the present invention, the FGR mixer may further comprise secondary inlet pipe. The secondary inlet pipe is communicated to the mixing shell to define the secondary internal opening and to eject exhaust gas in the secondary flow direction. The secondary inlet pipe provides a center axis that intersects with the center axis of the primary inlet pipe. According to the invention, it is possible to efficiently suck exhaust gas by vacuum created by fresh air flow, and to suppress pressure loss of exhaust gas.

In one of aspects of the present invention, the primary inlet pipe is decreased in diameter to provide a decreased diameter at an upstream side to the primary internal opening. The mixing shell is disposed in a coaxial manner with the primary inlet pipe, and has a pipe portion which defines the external opening having an outlet diameter at a downstream end thereof. The outlet diameter is equal to or less than the decreased diameter, where an upstream side and a downstream side are defined based on a direction of fresh air flow on the center axis of the primary inlet pipe. According to the invention, it is possible to suppress pressure loss caused by excessive expansion of fresh air ejected from the primary internal opening.

### BRIEF DESCRIPTION OF THE DRAWINGS

Additional objects and advantages of the present invention will be more readily apparent from the following detailed description of preferred embodiments when taken together with the accompanying drawings. In which:

FIG. 1 is a block diagram showing an intake and exhaust system for an internal combustion engine according to a first embodiment of the invention;

FIG. 2A is a side view of an EGR mixer according to the first embodiment of the invention;

FIG. 2B is a cross-sectional view of the EGR mixer along a IIB-IIB line in FIG. 2A;

FIG. 2C is a cross-sectional view of the EGR mixer along a IIC-IIC line in FIG. 2A;

FIG. 3 is a perspective view of the EGR mixer according to the first embodiment of the invention;

FIG. 4 is a side view of the EGR mixer showing a relationship between a position of a primary internal opening and a position of a secondary internal opening along a center axis of a passage way provided by a primary inlet pipe according to the first embodiment of the invention;

FIG. 5 is a streamline diagram showing streamlines of fresh air and exhaust gas in the EGR mixer according to the first embodiment of the invention;

FIG. 6A is a side view of an EGR mixer according to a comparative embodiment;

FIG. 6B is a cross-sectional view of the EGR mixer along a VIB-VIB line in FIG. 6A;

FIG. 7A is a graph showing a correlation obtained by plotting pressure loss of exhaust gas from a secondary internal opening to an external opening with respect to parameters, which is a relationship between a position of an upstream end of a primary internal opening and a position of an upstream end of a secondary internal opening;

FIG. 7B is a graph showing a correlation obtained by plotting an amount of exhaust gas being capable of contributing to restrict a fresh air flow by passing through a primary internal opening with respect to parameters, which is a relationship between a position of a downstream end of a primary internal opening and a position of a downstream end of a secondary internal opening;

FIG. 8A is a side view of an EGR mixer according to a modified embodiment;

FIG. 8B is a cross-sectional view of the EGR mixer along a VIIIB-VIIIB line in FIG. 8A; and

FIG. 9 is a partial cross sectional view showing connecting surfaces according to a modified embodiment.

### DETAILED DESCRIPTION OF THE PREFERRED EMBODIMENTS

With reference to the accompanied drawings, variety of embodiments of EGR mixers will be described. EGR mixers in this disclosure include a primary inlet pipe and a mixing shell. The primary inlet pipe is formed to eject fresh air with an increased flow velocity and a decreased pressure by restricting fresh air flow. The mixing shell provides a mixing cavity, which may be also called as a mixing space or a mixing chamber. The mixing shell is connected to the primary inlet pipe or formed integrally with the primary inlet pipe. The mixing cavity sucks exhaust gas by using vacuum pressure created by ejecting fresh air from the primary inlet pipe.

The mixing shell defines a primary internal opening, a secondary internal opening, and an external opening. The primary internal opening provides an outlet opening of the primary inlet pipe for ejecting fresh air. The secondary internal opening provides an outlet opening for exhaust gas. The secondary internal opening is formed to open at a radial outside position to an ejected fresh airflow from the primary internal opening.

The primary internal opening defines an opening plane on which the primary internal opening opens to the mixing cavity. The primary internal opening is formed so that the opening plane is positioned to intersect a center axis of a passage way provided by the primary inlet pipe at a non-right angle. The primary internal opening is also formed so that the opening plane is inclined to a side where the opening plane faces the secondary internal opening. The secondary internal opening may define a secondary flow direction which corresponds to a flow direction of exhaust gas in the secondary internal opening. The secondary internal opening is positioned on a position where exhaust gas flowing out from the secondary internal opening can pass through or enter into the primary internal opening by flowing in straight along the secondary flow direction.

Since the opening plane defined by the primary internal opening is inclined to face the secondary internal opening, a side of the opening plane where the secondary internal opening is not placed may be referred to as an up side (UP). A side of the opening plane where the secondary internal opening is placed may be referred to as a down side (DW). The mixing shell defines the mixing cavity only on the down side DW, and does not define the mixing cavity on the up side UP. The opening plane may define an upstream side (UST) of fresh air and a downstream side (DST) of fresh air. The downstream side DST of the opening plane corresponds to a side where the secondary internal opening is placed. Therefore, the mixing shell defines the mixing cavity only on the downstream side DST, and does not define the mixing cavity on the upstream side UST. In other words, on cross-sections perpendicular to the primary internal opening, a circumferential region about a longer axis of the primary internal opening may be divided into two halves of circumferential regions by the opening plane. One half region includes the secondary internal opening. The other half region is located opposite to the secondary internal opening. The mixing cavity is formed only on the half region where the secondary internal opening is placed. The mixing cavity is not formed on the remaining half region opposite to the secondary internal opening.

### FIRST EMBODIMENT

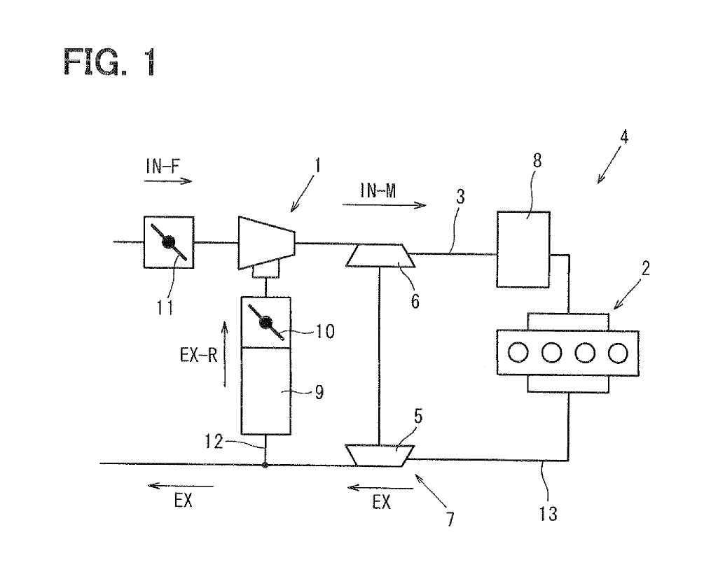

FIG. 1 is a block diagram of an intake and exhaust system for an internal combustion engine (engine) 2. The system includes an exhaust gas recirculation (EGR) system which includes an EGR mixer 1 according to a first embodiment of the invention. The EGR mixer 1 is a component of an intake and exhaust system 4 for the engine 2. The EGR mixer 1 is installed in an intake passage 3 of the engine 2. The EGR mixer 1 contributes to perform an exhaust gas recirculation (EGR) process in which a part of exhaust gas (EX) exhausted from the engine 2 is returned to the intake passage 3 and is sucked into the engine 2. The EGR mixer 1 creates mixture (IN-M) by mixing returned exhaust gas (EX-R) into fresh air (IN-F).

The intake and exhaust system 4 includes a plurality of components, such as a turbo charger 7, an inter cooler 8, an EGR cooler 9, an EGR valve 10, and a throttle valve 11. The turbo charger 7 has a turbine 5 and a compressor 6. The turbo charger 7 compresses a mixture gas (IN-M), which is an intake gas to be introduced into the engine 2, by using energy of exhaust gas flow. The inter cooler 8 cools the mixture gas compressed by the turbo charger 7. The EGR cooler 9 cools the exhaust gas which is mixed into the fresh air at the EGR mixer 1. Exhaust gas to be mixed into the fresh air may be referred to as EX-R. The EGR valve 10 adjusts an amount of exhaust gas to be supplied to the EGR mixer 1 from the EGR cooler 9, The throttle valve 11 restricts the fresh air flow at an upstream side of the EGR mixer 1.

An EGR passage 12 is provided to circulate a part of exhaust gas to the intake. The EGR passage 12 connects a portion of the exhaust passage 13 at a downstream side of the turbine 5 and a portion of the intake passage 3 at an upstream side of the compressor 6. The EGR mixer 1 is a component to provide a connecting portion between the intake passage 3 and the EGR passage 12.

The EGR mixer 1 creates the Venturi effect on the fresh air flow, and mixes fresh air and exhaust gas by making the fresh air flow to suck exhaust gas. That is the EGR mixer 1 increases velocity of the fresh air flow and decreases pressure of fresh air by restricting the fresh air flow. The EGR mixer 1 sucks exhaust gas by creating vacuum by ejecting fresh air with decreased pressure. The EGR mixer 1 also mixes fresh air and exhaust gas.

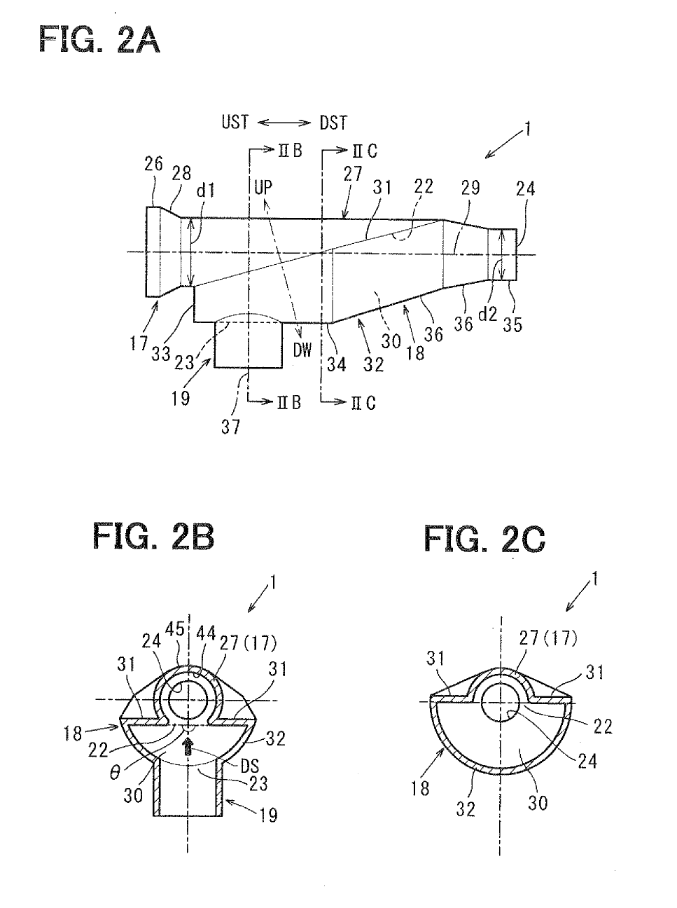

FIG. 2A shows a side view of the EGR mixer 1. FIG. 2B shows a cross-sectional view of the EGR mixer 1 at a cross-sectional plane which is perpendicular to a center axis 29 of a primary inlet pipe 17. FIG. 2C shows a cross-sectional view of the EGR mixer 1 at a cross-sectional plane which is perpendicular to a center axis 29 of the primary inlet pipe 17 and is positioned just downstream side of a secondary internal opening 23 of a secondary inlet pipe 19. FIG. 2C shows a cross-sectional view of the EGR mixer 1 at a cross-sectional plane which is perpendicular to the center axis 29 and is positioned at a position where the opening plane of the primary internal opening 22 and the center axis 29 crosses.

As shown in FIGS. 2A-2C, the EGR mixer 1 includes a primary inlet pipe 17, a mixing shell 18, and a secondary inlet pipe 19. The primary inlet pipe 17 introduces fresh air to a place where fresh air meets exhaust gas. The primary inlet pipe 17 provides a restrictor that restricts a fresh air flow and an ejector outlet that ejects the fresh air flow. The primary inlet pipe 17 ejects the fresh air flow with an increased velocity of the fresh air flow and a decreased pressure of fresh air, which are created by restricting the fresh air flow. The mixing shell 18 is connected to the primary inlet pipe 17. The mixing shell 18 defines a mixing cavity 30. An ejected fresh air flow from the primary inlet pipe 17 creates vacuum in the mixing cavity 30. The mixing shell 18 sucks exhaust gas into the mixing cavity 30 by vacuum created by the ejected fresh air flow. The mixing shell 18 also mixes fresh air and exhaust gas in the mixing cavity 30. The secondary inlet pipe 19 is connected to the mixing shell 18 and defines an opening for introducing exhaust gas into the mixing cavity 30 defined in the mixing shell 18. The secondary inlet pipe 19 introduces and ejects exhaust gas into the mixing cavity 30.

An outlet opening of the primary inlet pipe 17 is referred to as a primary internal opening 22. An outlet opening of the secondary inlet pipe 19, i.e. an opening for ejecting exhaust gas into the mixing cavity 30, is referred to as a secondary internal opening 23. A flow direction of exhaust gas at the secondary internal opening 23 is referred to as the secondary flow direction DS. The secondary inlet pipe 19 is communicated to the mixing shell 18 to define the secondary internal opening 23 and to eject exhaust gas in the secondary flow direction DS. The secondary inlet pipe 19 provides a center axis 37, i.e. the secondary flow direction DS, that intersects with the center axis 29 of the primary inlet pipe 17. That is, the secondary inlet pipe 19 defines the secondary internal opening 23 by communicated to the mixing shell 18, and ejects exhaust gas into the mixing shell 18 in the secondary flow direction DS. The mixing shell 18 also defines an outlet opening for mixture. The outlet opening for mixture is referred to as an external opening 24.

The primary inlet pipe 17 defines a large diameter portion 26, a small diameter portion 27, and a restricting portion 28. The large diameter portion 26 is formed in a cylindrical shape. The large diameter portion 26 introduces and accepts fresh air from the intake passage 3 which is located on an upstream side of the EGR mixer 1. The small diameter portion 27 is formed on the same axis of the large diameter portion 26. The small diameter portion 27 has a diameter that is smaller than that of the large diameter portion 26. The small diameter portion 27 defines the primary internal opening 22. The restricting portion 28 is formed in a tapered shape in which diameter gradually decreased from the large diameter portion 26 to the small diameter portion 27. The restricting portion 28 restricts the fresh air flow. The restricting portion 28 smoothly connects the large diameter portion 26 and the small diameter portion 27 to gradually narrow cross-sectional area of the primary inlet pipe 17.

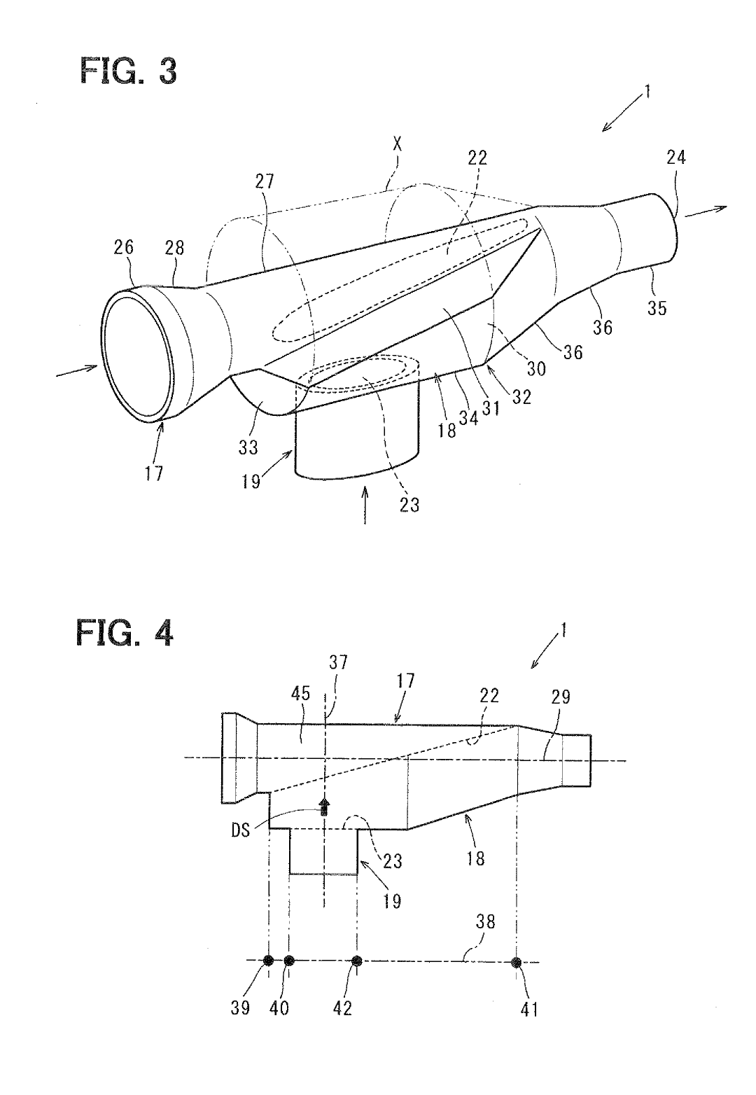

The small diameter portion 27 presents a cylindrical shape with the primary internal opening 22 that is an oblique opening. The primary internal opening 22 presents the oblique opening that may be provided by cutting a cylinder in an oblique manner. The primary internal opening 22 defines an opening plane. The opening plane intersects the center axis 29 of the primary inlet pipe 17 at a non-right angle. The primary internal opening 22 defines an ellipse shape at the opening plane, as shown in FIG. 3. FIG. 3 is a perspective view of the EGR mixer 1.

The secondary inlet pipe 19 is positioned to intersect perpendicular to the primary inlet pipe 17. The secondary internal opening 23 opens on a radial outside of the fresh air flow ejected from the primary internal opening 22. That is, the secondary internal opening 23 opens at a radial outside with respect to the center axis 29 of the primary inlet pipe 17. The small diameter portion 27 is formed in a shape which may be provided by obliquely cutting away a part of a pipe, which is an imaginary original shape of the small diameter portion 27. The primary internal opening 22 defines an opening plane on which the primary internal opening 22 opens to the mixing cavity 30. The opening plane is tilted to the center axis 29 to face the secondary internal opening 23. The external opening 24 is formed on a downstream side of both the primary internal opening 22 and the secondary internal opening 23 in the direction of the fresh air flow in the primary inlet pipe 17.

The primary inlet pipe 17 and the secondary inlet pipe 19 are connected to the mixing shell 18. The mixing shell 18 defines the mixing cavity 30 which mixes fresh air from the primary inlet pipe 17 and exhaust gas from the secondary inlet pipe 19. Since the opening plane defined by the primary internal opening 22 is inclined to face the secondary internal opening 23, a side of the opening plane where the secondary internal opening 23 is not placed may be referred to as an up side (UP). A side of the opening plane where the secondary internal opening 23 is placed may be referred to as a down side (DW). The mixing shell 18 defines the mixing cavity 39 only on the down side DW, and does not define the mixing cavity 30 on the up side UR

In this embodiment, in order to design an outer shape of the mixing shell 18, it is assumed that the EGR mixer 1 has an imaginary cylindrical outer pipe X about the center axis 29. The imaginary cylindrical outer pipe X surrounds the primary inlet pipe 17. The imaginary cylindrical outer pipe X may be divided into an upper part and a lower part by the opening plane. As shown in FIG. 2 and FIG. 3, the mixing shell 18 presents a shape which corresponds to the lower part of the imaginary cylindrical outer pipe X, which can be provided by removing the upper part of the imaginary cylindrical outer pipe X. An upstream side and a downstream side may be defined along a direction of the fresh air flow on the center axis 29. The imaginary cylindrical outer pipe X has an upstream end approximately to an upstream end of the primary internal opening 22:

The mixing shell 18 is formed in a shape which corresponds to a half part of the imaginary cylindrical outer pipe X cut at the opening plane of the primary internal opening 22. The mixing shell 18 includes a flange 31, which may be provided by a part of separated wall. The flange 31 covers an upper side of the mixing cavity 30. The flange 31 outwardly extends from the outer rim of the primary internal opening 22 in radial direction. The flange 31 extends parallel to the opening plane of the primary internal opening 22. The mixing shell 18 includes a surrounding portion 32 which is provided by an outer wall of the imaginary cylindrical outer pipe X. The mixing shell also includes an end wall portion 33 which closes an upstream end of the surrounding portion 32.

The mixing shell 18 defines a mixing cavity 30 formed in a fan shape, i.e. a sector of a circle or a ring, in cross section at a cross-sectional plane perpendicular to the center axis 29. A center angle θ (Theta) of the fan shaped cross section is equal to 180 degrees at the cross-sectional plane perpendicular to the center axis 29. The mixing cavity 30 may be formed in a fan shape to define the center angle less than 180 degrees. The center angle θ may be defined by both ends of the fan shaped cross section as shown in FIG. 2B. Both ends of the fan shaped cross section, i.e. the flange 31, are parallel to the opening plane of the primary internal opening 22. Therefore, the mixing cavity 30 does not extend to the up side UP beyond the opening plane of the primary internal opening 22. The center angle θ of the mixing cavity 30 may be equal to or less than 180 degrees at the cross-sectional plane which is perpendicular to the center axis 29 and includes a center axis 37 of the secondary inlet pipe 19.

In this embodiment, the imaginary cylindrical outer pipe X has an inlet cylindrical section, a cone section, and an outlet cylindrical section, which are coaxially disposed on the center axis 29. The surrounding portion 32 of the mixing shell 18 is a part of the imaginary cylindrical outer pipe X. The inlet cylindrical section may be referred to as a large diameter portion 34 which is located on an upstream end of the mixing shell 18. The large diameter portion 34 is connected to the secondary inlet pipe 19 and defines the secondary internal opening 23, The outlet cylindrical section may be referred to as a small diameter portion 35. The small diameter portion 35 provides the external opening 24. The small diameter portion 35 may also be referred to as a pipe section. The small diameter portion 35 is formed smaller in diameter than the large diameter portion 34. The small diameter portion 35 is coaxially disposed to the large diameter potion 34. The cone section may be referred to as a restricting portion 36. The restricting portion 36 is formed in a tapered shape which becomes smaller in diameter from the large diameter portion 34 to the small diameter portion 35. The external opening 24 is formed in a circular shape.

Since the restricting portion 36 gradually decreased from the large diameter portion 34 to the small diameter portion 35 in a tapered cone manner, it provides cross sectional area gradually decreased along flow direction to a downstream end. While fresh air ejected from the primary internal opening 22 flows toward the external opening 24, exhaust gas is mixed with fresh air. The primary inlet pipe 17 is decreased in diameter to provide a decreased diameter d1 at an upstream side to the primary internal opening 22. The decreased diameter d1 is provided at the small diameter portion 27. The mixing shell 18 is disposed in a coaxial manner with the primary inlet pipe 17, and has a pipe portion which defines the external opening 24 having an outlet diameter d2 at a downstream end thereof. The outlet diameter d2 is provided by the small diameter portion 35. The outlet diameter d2 is equal to or less than the decreased diameter d1.

The secondary inlet pipe 19 is formed in a cylindrical shape, and is connected to the large diameter portion 34 of the mixing shell 18 to form the secondary internal opening 23. The secondary inlet pipe 19 has a downstream end that is the secondary internal opening 23. The secondary inlet pipe 19 is communicated with the mixing cavity 30 via the secondary internal opening 23. The secondary inlet pipe 19 is extending in a radial direction of the large diameter portion 34. The secondary inlet pipe 19 has a center axis 37 which perpendicularly intersects with the center axis 29 of both the mixing shell 18 and the primary inlet pipe 19. As mentioned above, the opening plane of the primary internal opening 22 inclines toward the secondary internal opening 23. In other words, the primary internal opening 22 and the secondary internal opening 23 are arranged to allow exhaust gas to flow in the secondary flow direction DS in straight from the secondary internal opening 23 to pass the primary internal opening 22.

In a case that the small diameter portion 27 is cut at a cross-sectional plane perpendicular to the center axis 29 of the primary inlet pipe 17, a cross section of the small diameter portion 27 is presented by an arc shape, and an imaginary cross section of the primary internal opening 22 may be presented by a chord connecting both ends of the arc shape. FIG. 2B and FIG. 2C show arc shapes on upper side and chords on lower side. Exhaust gas ejected in the secondary flow direction DS from the secondary internal opening 23 passes the chord, which is the primary internal opening 22, in the secondary flow direction DS. Then, exhaust gas ejected in the secondary flow direction DS from the secondary internal opening 23 enters into an inside region bounded by the chord and the arc shape, which is a passage way defined by the small diameter portion 27.

In this embodiment, an upstream side and a downstream side may be defined based on a direction of fresh air flow on the center axis 29 of the primary inlet pipe 22. In addition, it is possible to place an imaginary projection plane 38 which is perpendicular to the secondary flow direction DS. The primary internal opening 22 and the secondary internal opening 23 may be projected along the secondary flow direction DS onto the projection plane 38. The primary internal opening 22 and the secondary internal opening 23 are arranged so that an upstream end 39 of the projected area of the primary internal opening 22 is positioned on an upstream side to an upstream end 40 of the projected area of the secondary internal opening 23. The primary internal opening 22 and the secondary internal opening 23 are arranged so that a downstream end 41 of the projected area of the primary internal opening 22 is positioned on a downstream side to a downstream end 42 of the projected area of the secondary internal opening 23. FIG. 4 shows a side view of the EGR mixer 1. In the drawing, a relationship between a position of the primary internal opening 22 and a position of the secondary internal opening 23 along the center axis 29 of a passage way provided by the primary inlet pipe 17 is shown.

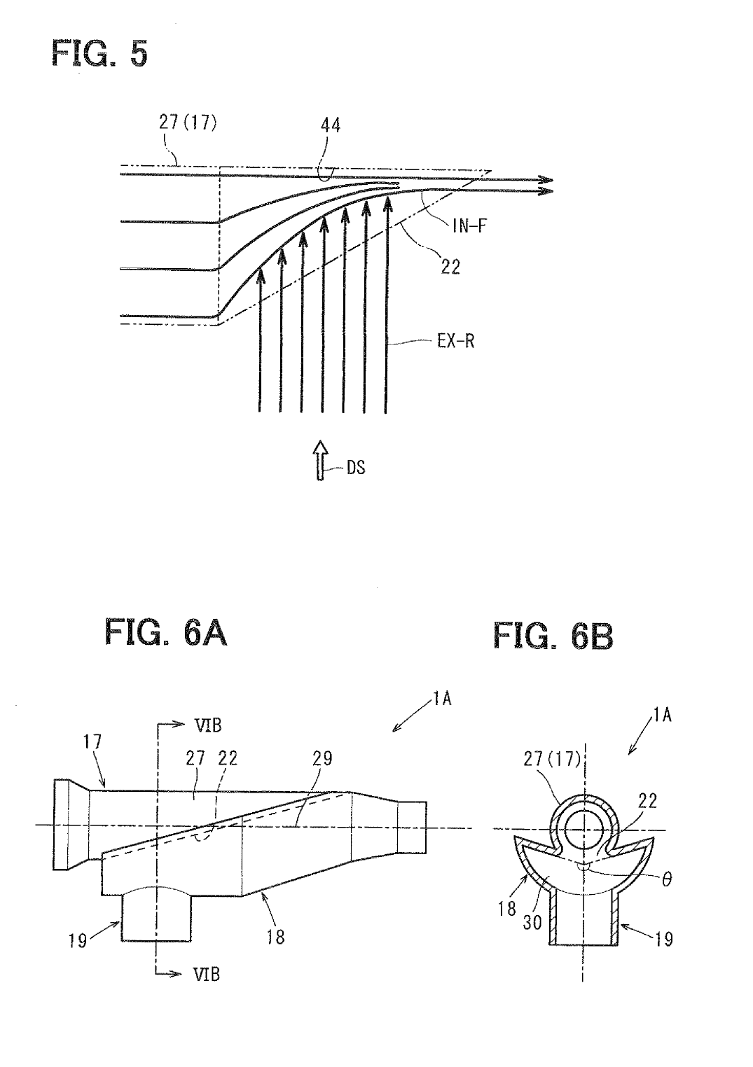

According to the above described structure, fresh air may be introduced into the EGR mixer 1 and is ejected from the primary internal opening 22. The fresh air flow ejected from the primary internal opening 22 creates vacuum within the mixing cavity 30. If needs arise, the EGR valve 10 may be opened during operation of the internal combustion engine 2. As the EGR valve 10 opens, the exhaust gas cooled by the EGR cooler 9 is sucked into the mixing cavity 30 via the secondary internal opening 23 by vacuum created by the fresh air flow. At this time, a part of exhaust gas ejected from the secondary internal opening 23 and straightly flows in the secondary flow direction DS may pass the primary internal opening 22 in a reverse direction and may enter into the small diameter portion 27. This reversal flow of the exhaust gas may flow to push the fresh air flow toward an inner wall 44 of the small diameter portion 27. FIG. 5 is a streamline diagram showing streamlines of fresh air and exhaust gas EX-R in the EGR mixer 1. As shown in FIG. 5, the reversal flow of the exhaust gas EX-R in the direction DS upwardly pushes the fresh air flow. Therefore, the fresh air flow compressed against the inner wall 44 may be more narrowly restricted and may create greater vacuum.

According to EGR mixer 1 described above, the primary internal opening 22 is formed as a shape which can be provided by cutting and removing a part of the small diameter portion 27 of the primary inlet pipe 17 at a side facing the secondary inlet pipe 19. Therefore, the primary internal opening 22 defines a opening plane which intersects the center axis 29 in a non-right angle, and the primary internal opening 22 directly faces the secondary internal opening along the secondary flow direction DS. It is possible to suppress pressure loss caused by excessive expansion of fresh air ejected from the primary internal opening 22 after restricted by the restricting portion 28.

The secondary inlet pipe 19 is connected to the mixing shell 18 so that exhaust gas flowing in straight along the secondary flow direction DS from the secondary internal opening 23 can pass the primary internal opening 22. Thereby, the exhaust gas passed the primary internal opening 22 in the secondary flow direction DS pushes the fresh air flow toward the inner wall 44 of the small diameter portion 27. Since the fresh air flow along the inner wall 44 may be more narrowly restricted to create greater vacuum, it is possible to increase sucking power to exhaust gas.

The mixing shell 18 defines the mixing cavity 30 only on the down side DW of the opening plane defined by the primary internal opening 22. The mixing shell 18 presents a shape which corresponds to the lower part of the imaginary cylindrical outer pipe X, which can be provided by removing the upper part of the imaginary cylindrical outer pipe X. The mixing cavity 30 is formed to have the fan shape that defines the center angle θ equal to 180 degrees on the cross sectional plane perpendicular to the center axis 29.

The arrangement reduces an amount of drifting exhaust gas, which is sucked into the mixing cavity 30, but does not pass the primary internal opening 22 and drifts within the mixing cavity 30. In other words, it is possible to reduce a possibility of exhaust gas sucked into the mixing cavity 30 via the secondary internal opening 23 becoming drifting flow which does not pass the primary internal opening 22. FIG. 6A shows a side view of a comparative example of an EGR mixer 1A. FIG. 6B shows a cross-sectional view of the comparative example of the EGR mixer 1A. In this comparative example, a mixing shell 18 is formed to surround the primary inlet pipe 17 beyond the primary internal opening 22. Therefore, a mixing cavity 30 is formed in a fan shape that defines a center angle θ larger than 180 degrees on the cross sectional plane perpendicular to the center axis 29.

According to the EGR mixer 1A, the mixing cavity 30 has side-spaces on both sides to the small diameter portion 27. Therefore, a part of exhaust gas ejected from the secondary inlet pipe 19 may flow into and drift into both side spaces, and does not pass the primary internal opening 22. Therefore, an amount of exhaust gas, which can contribute to restrict the fresh air flow in the small diameter portion 27, may be decreased. Pressure loss of exhaust gas may be increased.

On the other hand, according to the embodiment, exhaust gas ejected from the secondary inlet pipe 19 can not flow into both sides to the small diameter portion 27. Exhaust gas may easily pass and enter into the primary internal opening 22. The exhaust gas can effectively restrict a fresh air flow. Therefore, the fresh air flow can create increased vacuum by increased velocity caused by the exhaust gas entered into the primary internal opening. Therefore, it is possible to increase sucking power to exhaust gas.

According to the embodiment, it is possible to provide the EGR mixer 1 which can suppress pressure loss and increase an amount of exhaust gas.

The restricting portion 36 is designed to gradually decrease cross sectional area along flow direction to downstream end. Therefore, the mixing cavity 30 defines cross sectional area which gradually decreased along flow direction to a downstream end within a region from the primary internal opening 22 to the external opening 24. In comparison with a case that cross-sectional area of fluid passage is excessively decreased, it is possible to suppress pressure loss of exhaust gas flowing from the secondary internal opening 23 to the external opening 24.

Moreover, comparing the primary internal opening 22 and the secondary internal opening 23 on the projection plane 38, the upstream end 39 of the primary internal opening 22 is positioned upstream side rather than the upstream end 40 of the secondary internal opening 23. It is possible to suppress pressure loss caused by exhaust gas collision on the outer wall 45 of the small diameter portion 27.

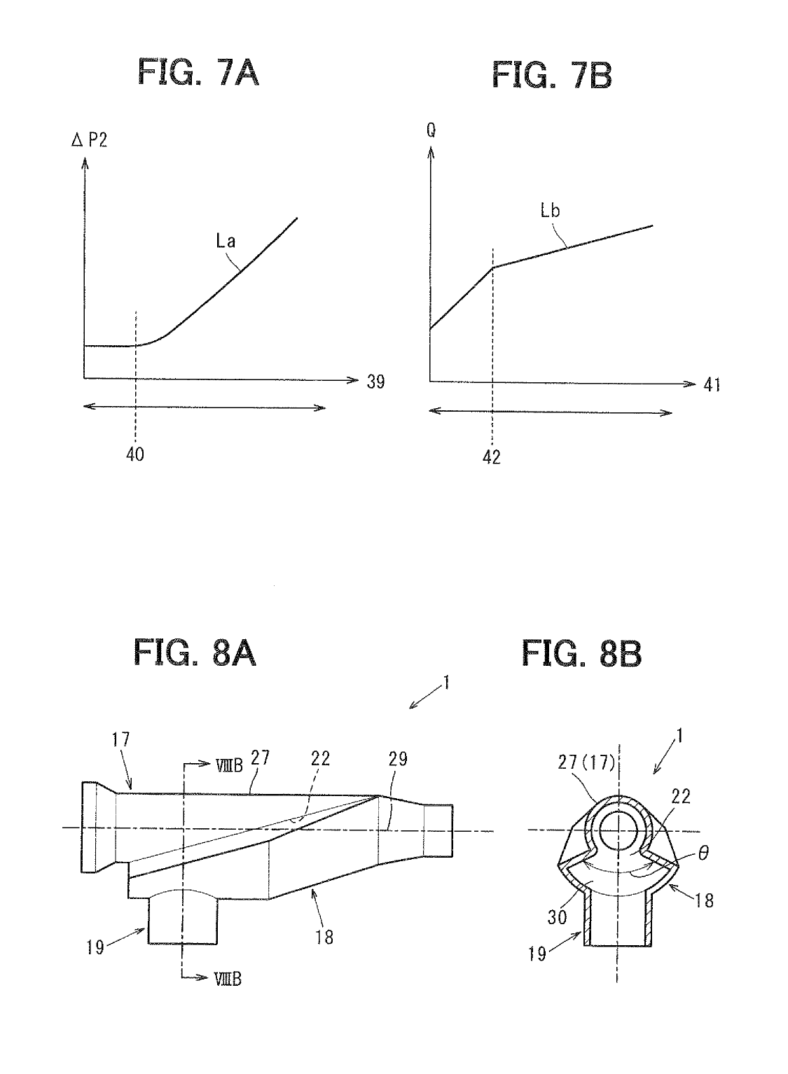

FIG. 7A is a graph showing a correlation between pressure loss of exhaust gas EX-R in a passage from the secondary internal opening 23 to the external opening 24 and parameters. The pressure loss of exhaust gas EX-R may also be referred to as ΔP2 (Delta-P-2). The parameters are position of the upstream end 39 of the primary internal opening 22 and the upstream end 40 of the secondary internal opening 23. A correlation line La shown in FIG. 7A may be obtained by plotting ΔP2 by using parameters, which shows a relationship between a position of the upstream end 39 and a position of the upstream end 40. In the plotting process, a relationship between a position of the downstream end 41 and a position of the downstream end 42 is fixed. The horizontal axis shows a relative position of the upstream end 39 with respect to the upstream end 40. The position of the upstream end 40 is shown by a broken line. Therefore, in the right side region from the broken line, the upstream end 39 is located on a downstream side from the upstream end 40. Therefore, in the left side region from the broken line, the upstream end 39 is located on an upstream side from the upstream end 40.

According to the correlation line La, ΔP2 can be maintained substantially constant, when the upstream end 39 is located in the upstream side rather than the upstream end 40. When the upstream end 39 is located in the upstream side rather than the upstream end 40, the exhaust gas flowing straight along the secondary flow direction DS from the upstream end 40 can pass the primary internal opening 22 without colliding with the outer wall 45 of the small diameter portion 27. In a range where the upstream end 39 is located in the upstream side rather than the upstream end 40, an amount of exhaust gas passing through the primary internal opening 22 may be maintained substantially constant, therefore, it is possible to maintain ΔP2 substantially constant.

If the upstream end 39 was located in the downstream side rather than the upstream end 40, exhaust gas flowing straight along the secondary flow direction

DS from the upstream end 40 might collide on the outer wall 45 and could not pass the primary internal opening 22. The more the upstream end 39 extends to the downstream side than the upstream end 40, the more amount of exhaust gas collides with the outer wall 45 and can not pass the primary internal opening 22. Therefore, the more the upstream end 39 extends to the downstream side than the upstream end 40, the more ΔP2 becomes.

As described above, it is possible to suppress pressure loss caused by exhaust gas colliding on the outer wall 45 by placing the upstream end 39 to the upstream side rather than the upstream end 40.

When the primary internal opening 22 and the secondary internal opening 23 are projected on the projection plane 38 along the secondary flow direction DS, the downstream end 41 of the projection range of the primary internal opening 22 is in the downstream side rather than the downstream end 42 of the projection range of the secondary internal opening 23. This arrangement effectively use exhaust gas ejected from the secondary internal opening 23 to restrict the fresh air flow.

FIG. 7B is a graph showing a correlation between an amount of exhaust gas being capable of contributing to restrict a fresh air flow at the small diameter portion 27 by passing through the primary internal opening 22 and parameters. The amount of exhaust gas contributing to restrict a fresh air flow within the small diameter portion 27 may also be referred to as Q. The parameters are position of the downstream end 41 of the primary internal opening 22 and the downstream end 42 of the secondary internal opening 23. A correlation line Lb shown in FIG. 7B may be obtained by plotting Q by using parameters, which shows a relationship between a position of the downstream end 41 and a position of the downstream end 42. In the plotting process, a relationship between a position of the upstream end 39 and a position of the upstream end 40 is fixed. The horizontal axis shows a relative position of the downstream end 41 with respect to the downstream end 42. The position of the downstream end 42 is shown by a broken line. Therefore, in the right side region from the broken line, the downstream end 41 is located on a downstream side from the downstream end 42. Therefore, in the left side region from the broken line, the downstream end 41 is located on an upstream side from the downstream end 42.

According to the correlation line Lb, an increasing rate of Q when the downstream end 41 is in the downstream side rather than the downstream end 42 is smaller than that when the downstream end 41 is in the upstream side rather than the downstream end 42. When the downstream end 41 is located in the downstream side rather than the downstream end 42, the exhaust gas flowing straight along the secondary flow direction DS from the downstream end 42 can pass the primary internal opening 22.

In a range where the downstream end 41 is located in the downstream side rather than the downstream end 42, an amount of exhaust gas passing through the primary internal opening 22 may be maintained substantially constant. For this reason, when the downstream end 41 is located in the downstream side rather than the downstream end 42, even if the downstream end 41 is extended in the downstream side, Q does not become large so much.

On the other hand, if the downstream end 41 is located in the upstream side rather than the downstream end 42, the exhaust gas flowing straight along the secondary flow direction DS from the downstream end 42 could change flow direction without passing the primary internal opening 22 and could flow toward the external opening 24. The more the downstream end 41 backwardly shrinks to the upstream side than the downstream end 42, the more amount of exhaust gas changes flow direction without passing the primary internal opening 22 and flows toward the external opening 24. Therefore, the more the downstream end 41 backwardly shrinks to the upstream side than the downstream end 42, the less Q becomes.

According to the correlation line Lb, an increasing rate of Q when the downstream end 41 is in the downstream side rather than the downstream end 42 is smaller than that when the downstream end 41 is in the upstream side rather than the downstream end 42. Therefore, the downstream end 41 arranged on the downstream side than the downstream end 42 effectively use exhaust gas ejected from the secondary internal opening 23 to restrict the fresh air flow.

The center axis 29 intersects with the center axis 37. This arrangement efficiently sucks exhaust gas by vacuum created by fresh air flow, and suppresses pressure loss of exhaust gas.

The diameter d2 of the small diameter portion 35 of the mixing shell 18 is equal to or smaller than the diameter d1 of the small diameter portion 27 of the primary inlet pipe 17. It is possible to suppress pressure loss caused by excessive expansion of fresh air ejected from the primary internal opening 22.

### MODIFIED EMBODIMENTS

The above described embodiments do not restrict the scope of the present invention. The invention can be practiced in various modified forms of EGR mixers. For example, the invention may be also applied to an EGR mixer as shown in FIGS. 8A and 8B. In this modified embodiment, the EGR mixer 1 has a mixing shell 18. The mixing shell 18 defines an imaginary removed part extending more than 180 degrees at a cross-sectional plane which is perpendicular to the center axis 29 and includes an axis of a secondary inlet pipe 19. The imaginary removed part is removed from the imaginary cylindrical outer pipe X (see FIG. 3) to define the mixing shell 18. That is, the mixing shell 18 defines a mixing cavity 30 formed in a fan shape which extends less than 180 degrees at a cross-sectional plane which is perpendicular to the center axis 29 and includes an axis of a secondary inlet pipe 19. In this modified embodiment, both ends of the fan shaped cross section of the mixing cavity 30 provides a pair of slant surfaces which defines a tapered path toward the primary internal opening 22. The tapered path gradually narrows width of the mixing cavity 30 as exhaust gas flows along the secondary flow direction DS from the secondary internal opening 23 to the primary internal opening 22. In other words, width of the mixing cavity 30 gradually widened as ejected fresh air flows from the primary internal opening 22 to the secondary internal opening 23.

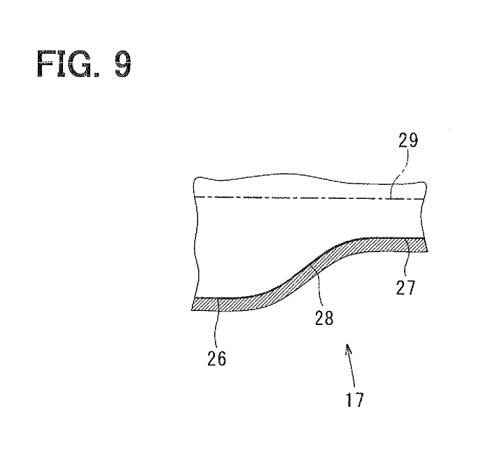

In addition to the above mentioned embodiments, surfaces connecting passage portions of the EGR mixer 1 may be formed in smooth or flashed surfaces. For example, a connecting surface between the restricting portion 28 and the large diameter portion 26 in the primary inlet pipe 17 may be formed in a smooth surface as shown in FIG. 9. For example, a connecting surface between the restricting portion 28 and the small diameter portion 27 in the primary inlet pipe 17 may be formed in a smooth surface as shown in FIG. 9. Similarly, a connecting surface between the restricting portion 36 and the large diameter portion 34 in the mixing shell 18 may be formed in a smooth surface. Also, a connecting surface between the restricting portion 36 and the small diameter portion 35 in the mixing shell 18 may be formed in a smooth surface.

Although the present invention has been fully described in connection with the preferred embodiments thereof with reference to the accompanying drawings, it is to be noted that various changes and modifications will become apparent to those skilled in the art. Such changes and modifications are to be understood as being within the scope of the present invention as defined by the appended claims.

What is claimed is:

1. An EGR mixer for mixing fresh air and exhaust gas in an exhaust gas recirculation system, comprising:
a primary inlet pipe which ejects fresh air with increased velocity and decreased pressure by restricting fresh air flow; and
a mixing shell connected to the primary inlet pipe and defining a mixing cavity, which sucks exhaust gas into the mixing cavity by using vacuum created by ejected fresh air and mixes fresh air and exhaust gas, wherein
the mixing shell defines primary internal opening which is an opening for ejecting fresh air from the primary inlet pipe into the mixing cavity; secondary internal opening which is an opening for introducing exhaust gas into the mixing cavity, and opens at a radial outside of fresh air flow from the primary internal opening; and external opening which is an outlet opening for mixture of fresh air and exhaust gas, and wherein
the primary internal opening defines an opening plane on which the primary internal opening opens to the mixing cavity, and is formed so that the opening plane is positioned to intersects a center axis of the primary inlet pipe at a non-right angle, and so that the opening plane is inclined to face the secondary internal opening,
the secondary internal opening is positioned at a position where exhaust gas flowing out from the secondary internal opening can pass through the primary internal opening by flowing in straight along a secondary flow direction which corresponds to a flow direction of exhaust gas at the secondary internal opening, and
the mixing shell defines the mixing cavity only on a side to the opening plane where the secondary internal opening is placed.

2. The EGR mixer claimed in claim 1, wherein
the mixing shell is provided by a part of an imaginary cylindrical pipe which is imaginarily disposed about a center axis of the primary inlet pipe to surround the primary inlet pipe, the part is only disposed on the side to the opening plane where the secondary internal opening is placed, and wherein
the mixing cavity is formed in a fan shape with a center angle equal to or less than 180 degrees at a cross section perpendicular to the center axis.

3. The EGR mixer claimed in claim 1, wherein
the mixing cavity defines cross sectional area which gradually decreased along flow direction to downstream within a region from the primary internal opening to the external opening.

4. The EGR mixer claimed in claim 1, wherein
the primary internal opening and the secondary internal opening are arranged so that an upstream end of a projected area of the primary internal opening is positioned on an upstream side to an upstream end of a projected area of the secondary internal opening, where an upstream side and a downstream side are defined based on a direction of fresh air flow on the center axis of the primary inlet pipe, and where the primary internal opening and the secondary internal opening are projected along the secondary flow direction onto a projection plane perpendicular to the secondary flow direction.

5. The EGR mixer claimed in claim 1, wherein
the primary internal opening and the secondary internal opening are arranged so that a downstream end of a projected area of the primary internal opening is positioned on a downstream side to a downstream end of a projected area of the secondary internal opening, where an upstream side and a downstream side are defined based on a direction of fresh air flow on the center axis of the primary inlet pipe, and where the primary internal opening and the secondary internal opening are projected along the secondary flow direction onto a projection plane perpendicular to the secondary flow direction.

6. The EGR mixer claimed in claim 1, further comprising:
secondary inlet pipe being communicated to the mixing shell to define the secondary internal opening and to eject exhaust gas in the secondary flow direction,
the secondary inlet pipe providing a center axis that intersects with the center axis of the primary inlet pipe.

7. The EGR mixer claimed in claim 1, wherein
the primary inlet pipe is decreased in diameter to provide a decreased diameter at an upstream side to the primary internal opening, and the mixing shell is disposed in a coaxial manner with the primary inlet pipe, and has a pipe portion which defines the external opening having an outlet diameter at a downstream end thereof, and the outlet diameter is equal to or less than the decreased diameter, where an upstream side and a downstream side are defined based on a direction of fresh air flow on the center axis of the primary inlet pipe.
